(19) United States
(12) Patent Application Publication
(10) Pub. No.: US 2024/0087769 A1
(43) Pub. Date: Mar. 14, 2024

(54) HYBRID COMPONENT AND PROCESS FOR PRODUCTION THEREOF

(71) Applicant: ERWIN QUARDER SYSTEMTECHNIK GMBH, Espelkamp (DE)

(72) Inventors: Johann FUNK, Espelkamp (DE); Alexander HEITBRINK, Stemwede (DE)

(73) Assignee: ERWIN QUARDER SYSTEMTECHNIK GMBH, Espelkamp (DE)

(21) Appl. No.: 18/367,219

(22) Filed: Sep. 12, 2023

(30) Foreign Application Priority Data
Sep. 12, 2022 (DE) 10 2022 123 119.4

(51) Int. Cl. H01B 7/00; H01B 7/02; H01B 13/00; H01B 13/06

(52) U.S. Cl. CPC H01B 7/0009; H01B 7/02; H01B 13/003; H01B 13/06

(57) ABSTRACT

A hybrid component has least one metal component, which has been overmolded with plastic at least in regions. A process for producing the hybrid component comprises processing a surface region of the metal component with a laser beam, and mounting and shrinking a shrink tube onto the processed surface region of the metal component or applying a sealing material to the processed surface region of the metal.

The present invention relates to an (injection-molded) hybrid component having at least one metal component, especially one that is solid, which has been overmolded with plastic at least in regions, especially in a fluid-tight manner, and to a process for producing such a hybrid component. The metal component that preferably consists of copper may especially be a conductor track for conduction of electrical current.

Such (injection-molded) hybrid components made from multiple materials, namely from plastic, and having metal component(s) in the form of conductor tracks, for example, are used in a wide variety of different technical fields: for instance in electric motors as a component that makes contact with the stator winding and via which the three phase lines of the electric motor are conducted to the outside.

In the case of components with metal components that are overmolded in an injection molding operation in the course of production, there is the risk in later use that leaks will arise between the metal component and the plastic surrounding it or that has been used for overmolding. Particularly temperature changes in later use, because of different coefficients of expansion of the materials involved, can cause microcracks between the plastic and the metal. Such microcracks—depending on the field of use—in turn possibly lead to unwanted leaks, corrosion etc.

DE 10 2006 001 340 discloses shrinking a shrink tube onto an insert part and then overmolding the insert part in that region in order thus to bring about sufficient leaktightness.

In practice, however, it has been found that the leaktightness thus achieved is inadequate or does not meet elevated demands.

Proceeding from this, it is an object of the present invention to further develop the production process cited at the outset for production of such a hybrid component with a metal component overmolded with plastic, and to specify a correspondingly further-developed hybrid component.

This object is achieved by a method having the features of claim 1 and by a component having the features of claim 7.

Accordingly, the process of the invention is characterized by the following features:
a) processing a surface region (13) of the metal component (11), especially by exposing it to a laser beam, such that nano- and/or microstructures are introduced into that surface region (13), especially nano- and/or microstructures that cause an increase in surface area in the surface region (13) (by comparison with an unprocessed or unstructured surface of the surface region) and/or have depressions comprising undercuts, and/or hooks,
b1) mounting and shrinking a shrink tube onto the processed surface region of the metal component, especially with the shrink tube in (direct) contact with the metal surface of the metal component, and then overmolding the mounted and shrunk shrink tube with plastic, especially with the plastic in (direct) contact with the shrink tube, or
b2) applying a sealing material, especially a layer thereof, to the processed surface region of the metal component, namely an elastomer, an adhesive, especially one having latent reactivity, or a varnish, especially with the sealing material in contact with the metal surface, and then overmolding the applied sealing material with plastic, especially with the plastic in contact with the sealing material.

The applicant has recognized that, surprisingly, the leaktightness or longevity of the leaktightness between metal component and overmolded plastic can be massively increased when the surface region of the metal component which is to be overmolded in the injection molding operation is first processed as specified, especially with a laser beam, and, in a first alternative of the invention and unlike in the prior art, it is only then that a/the shrink tube which is overmolded later on is shrunk onto the surface region to be processed. The processing of the surface with the laser beam distinctly increases the sealing effect, likely because of improved or interdigitated contact of the shrink tube with the metal component.

The processing of the surface region or the introduction of the nano- and/or microstructures described into the surface thereof, as an alternative to the exposure of the surface region to a laser beam from a laser, can also be effected by other physical and/or chemical nano- or microstructuring methods, for example by chemical etching.

The applicant has also recognized that, in a second alternative of the invention as well, it is possible to achieve elevated leaktightness between metal component and overmolded plastic. Thus, in this second alternative, especially in place of a shrink tube, it is possible to apply a special sealing material, namely an elastomer, an adhesive, preferably one having latent reactivity, or a varnish to the processed surface region, before the overmolding is then effected, such that the plastic is ultimately in contact with (the outside of) the sealing material, and such that the sealing material is between the plastic and the metal surface processed by the laser.

With regard to the metal component of the hybrid component, this may otherwise have (outer) edges in the processed surface region which is provided with the sealing material or onto which the shrink tube is mounted and shrunk. It has been found in an important development of the invention that rounding of these edges by mechanical processing prior to the processing of the surface region is likewise advantageous. It is thus possible in this way to achieve a more homogeneous distribution of stress, for example, after overmolding, and it is possible to minimize notch effects.

The metal component may independently be an elongate component, in which case the processed surface region may be a coherent strip running at an angle, especially transverse to the longitudinal extent thereof in circumferential direction. This strip may advantageously extend in a ring in circumferential direction along mutually adjacent (outer) faces of the metal component.

The metal component may otherwise have an inward narrowing or constriction on each of the opposite sides in the processed surface region. The shrink tube in this case has been or is advantageously mounted and shrunk on in the region of the narrowing or constriction.

With regard to the overmolding with the plastic, this is appropriately effected, especially in an injection molding operation, in an injection mold into which the metal component is inserted for this purpose.

If the sealing material is an elastomer as proposed, it may incidentally also be the case that this is applied to the processed surface region in an injection molding operation in an injection mold into which the metal component is inserted for this purpose. This is especially done in the same injection mold in which the overmolding of the sealing material with the plastic is effected thereafter.

The sealing material may also, if it is an adhesive or varnish as proposed, be applied in liquid form to the processed surface region. It may alternatively also be the case that the sealing material, if it is an adhesive, is applied as a film, especially a dry film, to the processed surface region.

It may also be the case here that the processed surface region and/or the adhesive film is heated before and/or during the application of the adhesive film to the processed surface region.

Especially in order to improve the sealing effect, it is otherwise possible to heat the processed surface region and/or the injection mold during the overmolding of the shrink tube or the sealing material with the plastic, especially by means of induction heating, by means of a laser, by means of a heat lamp, by means of an oven or by means of resistance heating.

Further features of the present invention will be apparent from the appended claims, the description of a preferred working example that follows, and the appended drawings. The drawings show:

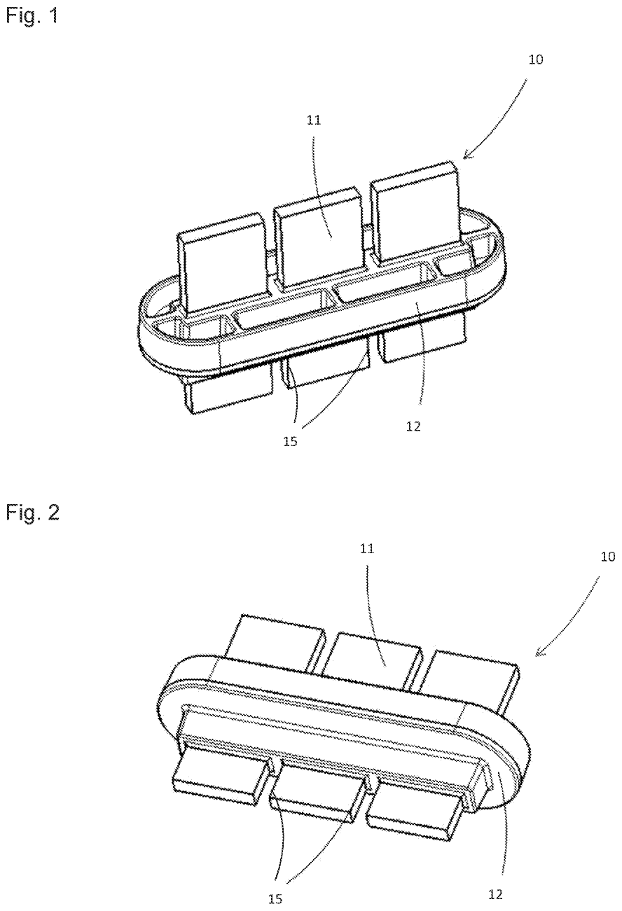

FIG. 1 a hybrid component produced by the process of the invention in a first oblique view,

FIG. 2 the hybrid component from FIG. 1 in a second oblique view,

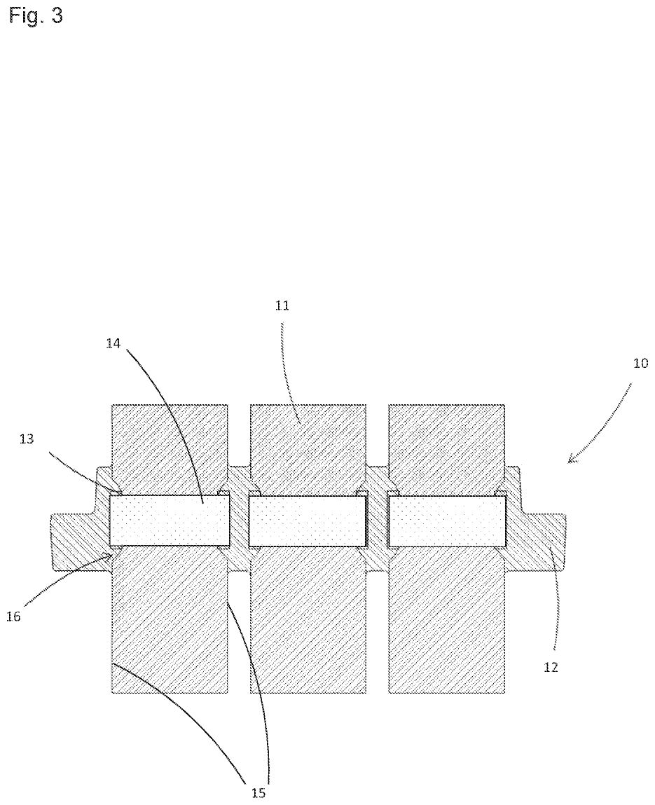

FIG. 3 a cross section through the hybrid component from FIG. 1,

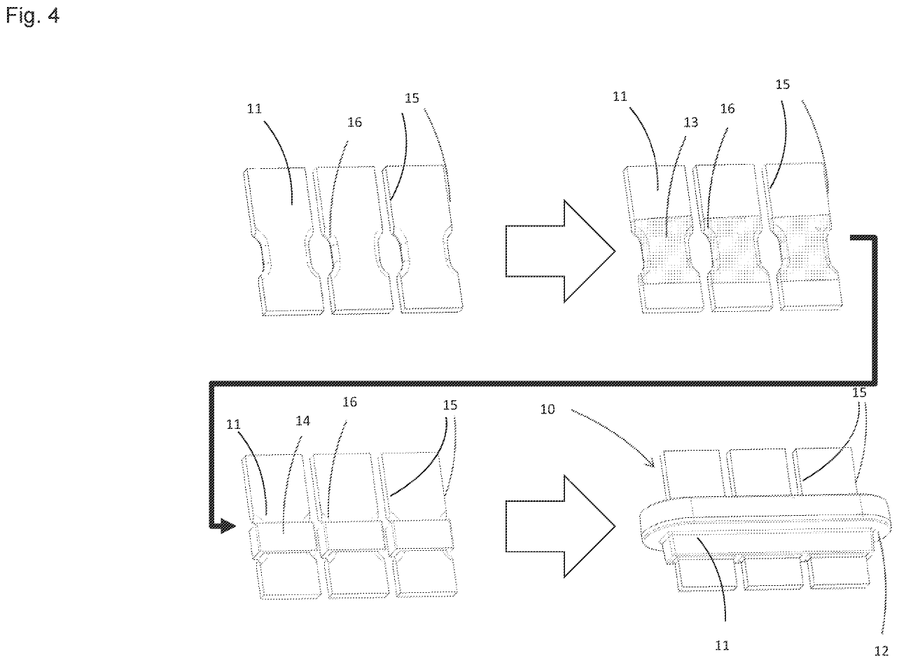

FIG. 4 various phases of the production of the hybrid component from FIG. 1.

The hybrid component 10 shown in FIG. 1 comprises three solid metal components 11, each of which is integrated into a common plastic component 12. Ultimately, the metal components 11 form metal bushings through the plastic component 12.

In the present working example, the solid metal components 11 are conductor tracks, especially composed of copper. Such hybrid components 10 having conductor tracks find use in electric motors, for example. However, it will be apparent that the present invention is not limited to such hybrid components.

The hybrid component 10 is an injection molding, in which case the metal components 11 are ultimately insert parts that have been overmolded with the plastic used in the injection molding process.

In order to significantly increase the leaktightness or the longevity of the leaktightness between the respective metal component 11 and the overmolded plastic, the hybrid component 10 is produced in accordance with the invention in a special way.

As shown in FIG. 4 in particular, the individual metal components 11, before being overmolded in the later injection molding process, are first processed in that surface region 13 in which they are subsequently overmolded or onto which the plastic is injected, in such a way that nano- and/or microstructures that are three-dimensional in particular are introduced into it, which bring about an increase in surface area in the surface region 13 and/or have depressions comprising undercuts, and/or hooks.

More preferably, these are introduced by exposure to a laser beam of a laser (not shown) or a laser unit. This is done in such a way that, in this surface region 13, the surface of the metal components 11 is altered in each case by at least partial melting of the metal material. But it is also possible to use other suitable methods, such as chemical etching.

In the present case, the processed surface region 13 is in strip form in each case and extends circumferentially (in circumferential direction) and coherently along four mutually adjacent sides of the metal component 11 which is virtually cuboidal in the present case, namely along two front sides and reverse sides of large area and along narrow sides that connect these. In the present case, this is angled relative to the longitudinal extent of the metal component 11 (here essentially perpendicularly).

It will be apparent that, depending on the application, the shape or outline of the surface region may also be different.

In the surface region 13 thus processed, a shrink tube 14 which is known per se is then mounted and shrunk on in each case.

Next, the metal components 11 are then inserted as insert parts into an injection mold (not shown) together with the shrink tube 14 and overmolded with the plastic of the later plastic component 12.

The prior processing of the surface region 13, as has been shown, massively increases leaktightness between the metal component 11 and the shrink tube 14, and hence ultimately also between the plastic component 12 and the metal component 11.

In order to achieve a more homogeneous distribution of stress and to minimize notch effects, it is additionally advantageous to round off the outer edges 15 of the metal components 11 in the processed surface region 13 by known mechanical methods, especially prior to the processing of the surface region 13; cf. FIG. 4 in particular.

It may further be the case that the metal components 11 are provided with an inward narrowing or constriction 16 on each of the opposite sides in the processed surface region 13, or that metal components 11 provided with these are used. Then the respective shrink tube 14 is mounted and shrunk onto this narrowing/constriction 16. This improves the fit of the respective shrink tube 14 on the processed surface region 13.

It has been found that, incidentally, it would also be possible to dispense with the shrink tube 14. Instead, it is alternatively also possible to use an adhesive layer, especially a layer of latently reactive hotmelt adhesive or an elastomer or a varnish.

Such latently reactive hotmelt adhesives have long been known. These are notable in that they are solid and storable at room temperature and curable at higher temperatures; cf. also EP 2712879A1 with further references.

The use of such adhesive in particular rather than the shrink tube 14 leads in a similar manner to the elevated leaktightness or longevity of leaktightness which is desired in accordance with the invention in the bond between metal component 11 and the adjoining plastic.

The same applies to the use of a varnish. Varnishes, in a manner customary in the art, comprise liquid or else pulverulent coating materials that are applied thinly to articles and, through chemical or physical processes (for example evaporation of the solvent), are built up to form a continuous, solid film. Varnishes generally consist of binders such as resins, dispersions or emulsions, fillers, pigments, solvents, and additives.

Elastomers are known to be dimensionally stable but elastically deformable plastics, the glass transition point of which is below the use temperature. These plastics can be elastically deformed under tensile and compressive stress, but then return to their original, undeformed shape.

### LIST OF REFERENCE NUMERALS

10 hybrid component
11 metal component
12 plastic component
13 processed surface region
14 shrink tube
15 outer edges
16 constriction

1. A process for producing a hybrid component having at least one metal component, which has been overmolded with plastic at least in regions, comprising the following steps:
a) processing a surface region of the metal component, such that nano- and/or microstructures are introduced into that surface region,
b1) mounting and shrinking a shrink tube onto the processed surface region of the metal component, or
b2) applying a sealing material to the processed surface region of the metal component.

2. The process as claimed in claim 1, wherein the metal component has edges in the surface region processed by the laser beam which is provided with the sealing material or on which the shrink tube is mounted and shrunk, and these edges are rounded off with the laser beam by mechanical processing prior to the processing of the surface region.

3. The process as claimed in claim 1, wherein the metal component is an elongate component, and the processed surface region is a coherent strip that runs at an angle.

4. The process as claimed in claim 1, wherein the metal component has an inward narrowing or constriction on each of the opposite sides in the processed surface region.

5. The process as claimed in claim 4, wherein the shrink tube is mounted and shrunk on in the region of the narrowing or constriction.

6. The process as claimed in claim 1, wherein the overmolding is effected in an injection molding operation in an injection mold into which the metal component is placed for this purpose.

7. The process as claimed in claim 1, wherein the sealing material, if it is an elastomer, is applied to the processed surface region in an injection molding operation in an injection mold into which the metal component is placed for this purpose.

8. The process as claimed in claim 1, wherein the sealing material, if it is an adhesive or varnish, is applied in liquid form to the processed surface region, or the sealing material, if it is an adhesive, is applied as a film to the processed surface region.

9. The process as claimed in claim 1, wherein the processed surface region and/or the adhesive film is heated before and/or during the application of the adhesive film to the processed surface region.

10. The process as claimed in claim 1, wherein the processed surface region and/or the injection mold is heated during the overmolding of the shrink tube or sealing material with the plastic.

11. A hybrid component having at least one metal component, which has been overmolded with plastic at least in regions, wherein the metal component, in a surface region provided with nano- and/or microstructures by processing, has a shrink tube that has been shrunk on there, or a layer of a sealing material, and the shrink tube or the sealing material has been overmolded with the plastic on its side remote from the processed surface region with the plastic in contact with the shrink tube or with the sealing material.

12. The hybrid component as claimed in claim 11, wherein the hybrid component has multiple elongate metal components in the form of conductor tracks, arranged parallel to one another, each of which has a surface region that has been processed by laser, and which has such an adjoining shrunk-on shrink tube or such a layer of sealing material applied to the processed surface region, wherein the processed surface regions of the multiple conductor tracks have been jointly overmolded with plastic.

13. (canceled)
